(19) United States
(12) Patent Application Publication
(10) Pub. No.: US 2014/0290215 A1
(43) Pub. Date: Oct. 2, 2014

(54) EMISSIONS CONTROL FOR ENGINE SYSTEM

(71) Applicant: CATERPILLAR INC., Peoria, IL (US)

(72) Inventors: Arvind Sivasubramanian, Peoria, IL (US); Christopher F. Gallmeyer, Peoria, IL (US)

(73) Assignee: Caterpillar Inc., Peoria, IL (US)

(21) Appl. No.: 13/852,342

(22) Filed: Mar. 28, 2013

(51) Int. Cl. F02D 41/02

(52) U.S. Cl. CPC F02D 41/0295
USPC 60/274; 60/285

(57) ABSTRACT

A method for controlling emissions in an engine system including an internal combustion engine and a catalytic converter with oxygen storage capacity. The method includes determining a real time oxygen storage level of the three-way catalytic converter based on a real time exhaust gas flow rate and a real time measured upstream oxygen quantity with respect to the catalytic converter. Further, maintaining an optimal oxygen storage level of the three-way catalytic converter for different types of fuel used in the internal combustion engine.

### TECHNICAL FIELD

The present disclosure relates to an engine system equipped with a three-way catalytic converter with oxygen storage capacity, and more particularly to a system and method for controlling emissions in the engine system.

### BACKGROUND

Three-way catalytic converters are commonly used in the exhaust system of rich-burn or stoichiometric engine systems to control emissions. Oxygen content present in the exhaust gas is decisive for an exemplary three-way catalytic converter to control emissions. Usually, an optimal level of oxygen content stored in the three-way catalytic convertor is required to lie within a narrow range to effectively control emission. Further, emissions control characteristics for the three-way catalytic convertor in a rich-burn or stoichiometric engine system may vary based on a switch in the type of fuel used in an internal combustion engine.

U.S. Pat. No. 5,901,552 (the '552 patent) discloses a method for adjusting the air-to-fuel ratio for an internal combustion engine having a catalytic converter connected downstream thereof. The catalytic converter is capable of storing oxygen present in the exhaust gas. The oxygen content present in the exhaust gas is detected upstream and downstream of the catalytic converter and the air-to-fuel ratio is accordingly controlled to maintain the oxygen fill level of the catalytic converter is maintained at an optimal level. The '522 patent describes a mathematical model to measure a real time oxygen storage level of the catalytic converter based on the detected oxygen content.

### SUMMARY

In an aspect, the present disclosure provides a method for controlling emissions in an engine system. The engine system includes an internal combustion engine and a catalytic converter with oxygen storage capacity. The method includes receiving a real time exhaust gas flow rate and a real time measured upstream oxygen quantity with respect to the catalytic converter. A real time oxygen storage level of the catalytic converter is determined based on the exhaust gas flow rate and the measured upstream oxygen quantity. Further, based on the real time oxygen storage level, the oxygen storage level in the catalytic converter is maintained at an optimal level for different types of fuel used in the internal combustion engine.

In another aspect, the present disclosure provides a control system for controlling emissions in the engine system including an internal combustion engine configured to operate using different types of fuel. The control system is configured to update at least one control parameter based on a switch in a type of fuel used in the internal combustion engine and determine the real time oxygen storage level of the catalytic converter using a mathematical model based on the at least one control parameter. The control system is further configured to output a fuel mass flow rate signal indicative of a desired fuel mass flow rate based on the real time oxygen storage level to maintain the optimal oxygen storage level of the catalytic converter.

In another aspect, the present disclosure provides a method of operating an engine system having the internal combustion engine configured to operate using different types of fuel. The method includes updating the at least one control parameter based on the switch in a type of fuel used in the internal combustion engine and determining the real time oxygen storage level of the catalytic converter using the mathematical model based on the at least one control parameter. Further, maintaining the optimal oxygen storage level of the catalytic converter based on the real time oxygen storage level for controlling emissions.

Other features and aspects of this disclosure will be apparent from the following description and the accompanying drawings.

### BRIEF DESCRIPTION OF THE DRAWINGS

FIG. 1 illustrates a schematic of an engine system;

FIG. 2 illustrates a block diagram of the control system, according to an embodiment of the present disclosure;

FIG. 3 illustrates an exemplary interpolation curve to update a first control parameter for use in a mathematical model; and

FIG. 4 illustrates a flow chart of a method for operating the engine system.

### DETAILED DESCRIPTION

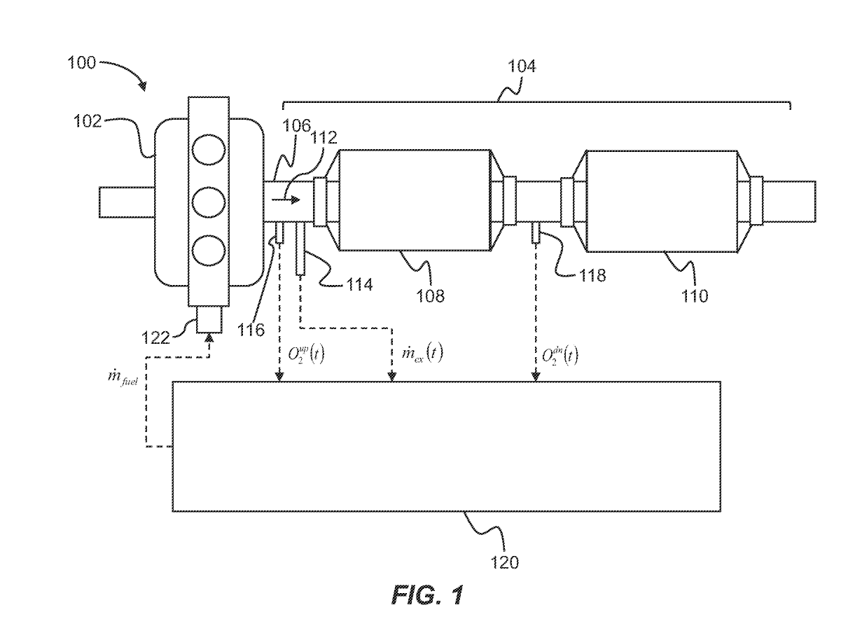

The present disclosure describes a system and a method to regulate fuel mass flow rate and/or air-to-fuel ratio in an internal combustion engine to maintain oxygen storage level of a three-way catalytic convertor (TWC) at an optimal level. FIG. 1 illustrates a schematic of an engine system 100. The engine system 100 may include an internal combustion engine 102, and an exhaust system 104. The internal combustion engine 102 may be any type of engine, for example, a spark-ignited internal combustion engine, a compression ignition internal combustion engine, can be of any size, with any number of cylinders, and in any configuration (“V,” in-line, radial, etc.). Further, the internal combustion engine 102 may operate using different types of fuel, for example, but not limited to, gasoline, diesel, methane, propane or any other fuels known in the art.

The internal combustion engine 102 may operate at different air-to-fuel ratio (AFR), which is a measure of mass ratio of air to fuel present in the internal combustion engine 102. Air-to-fuel ratio for a fuel-air mixture may be expressed as a lambda value (λ), which is equal to the ratio of air-to-fuel ratio (AFR) of the fuel-air mixture to the stoichiometric air-to-fuel ratio (AFR_{Stoich}) of a stoichiometric fuel-air mixture. The stoichiometric fuel-air mixture corresponds to a chemically accurate fuel-air mixture for stoichiometric combustion to occur in the internal combustion engine 102. Further, during the stoichiometric mode of operation of the internal combustion engine 102, λ is equal to 1.0. The internal combustion engine 102 may also operate at non-stoichiometric modes, for example, during a rich mode or a lean mode. Particularly, when the internal combustion engine 102 is operating in the rich mode, a high level of fuel is present than as needed for stoichiometric combustion, and during the rich mode λ is less than 1.0. Conversely, when the internal combustion engine 102 is operating in the lean mode, a lower level of fuel is present than as needed for stoichiometric combustion, and during the lean mode λ is greater than 1.0.

The exhaust system 104 may include an exhaust passage 106, a three-way catalytic converter (TWC) 108 with oxygen storage capacity, and a NOx-adsorber catalyst 110. During operation, exhaust gas 112 produced by combustion of the fuel-air mixture in the internal combustion engine 102 may be delivered to the three-way catalytic converter 108 via the exhaust passage 106. As well known in the art, the three-way catalytic converter 108 may oxidize or reduce harmful emissions present in the exhaust gas 112 such as, carbon monoxide (CO), volatile organic compounds (VOCs), and/or NOx into carbon dioxide, water and elemental nitrogen (N₂). The three-way catalytic converter 108 may include one or more catalytic elements including, for example, platinum, palladium, and/or rhodium etc., which may facilitate oxidation of CO, VOCs, and/or NOx into carbon dioxide, water, and N₂. Further, the three-way catalytic converter 108 is adapted to store an excess amount of oxygen (O₂) present in the exhaust gas 112, when the internal combustion engine 102 is operating in the lean mode.

In an aspect of the present disclosure, the engine system 100 includes an exhaust gas mass flow sensor 114, provided in the exhaust passage 106. The exhaust gas mass flow sensor 114 is adapted to determine a real time exhaust gas flow rate \dot{m}ₑₓ(t). The exhaust gas flow rate sensor 114 is configured to output a voltage or a pulse-width modulation (PWM) signal that is proportional to \dot{m}ₑₓ(t). In an embodiment, the exhaust gas mass flow sensor 114 may be a vane meter sensor or a hot wire sensor. However, other type of mass flow sensors which are well known in the art may be used to determine \dot{m}ₑₓ(t) without limiting the scope of the present disclosure.

Furthermore, the engine system 100 may include an upstream oxygen sensor 116 and a downstream oxygen sensor 118, which are arranged upstream and downstream of the three-way catalytic converter 108, respectively. The upstream oxygen sensor 116 and the downstream oxygen sensor 118 may be lambda probes and configured to output voltage or pulse-width modulation (PWM) signals proportional to a real time measured upstream oxygen quantity O₂^{up}(t) and a real time measured downstream oxygen quantity O₂^{dn}(t) with respect to the three-way catalytic converter 108, respectively. The engine system 100 may further include a control system 120 for controlling emissions in the engine system 100. The control system 120 configured to maintain an optimal oxygen storage level O₂^{Desired-Stored} of the three-way catalytic converter 108 to maintain tailpipe emissions below a threshold as per an emissions performance standard. It will be apparent to a person having ordinary skill in the art that the emissions performance standards are requirements that set/limit the threshold to the amount of the harmful emissions present in the exhaust gas 112 released by the engine system 100 into the environment.

According to an embodiment of the present disclosure, the control system 120 is configured to determine a real time oxygen storage level O₂^{Stored}(t) of the three-way catalytic converter 108 based on rim (t) and O₂^{dn}(t) received from the exhaust gas mass flow sensor 114 and the upstream oxygen sensor 116, respectively. Further, the control system 120 is configured to output a fuel mass flow rate signal indicative of a desired fuel mass flow rate \dot{m}_{fuel} based on O₂^{Stored}(t) to maintain the optimal oxygen storage level O₂^{Desired-Stored} of the catalytic converter. The fuel mass flow rate signal may adjust a fuel supply device 122 (e.g. a fuel valve or a carburetor) to minimize a deviation of O₂^{Stored}(t) from O₂^{Desired-Stored} for different types of fuel used in the internal combustion engine 102. It will be apparent to a person having ordinary skill in the art that the control system 120 is operatively connected to the fuel supply device 122 to regulate the fuel mass flow rate and/or air-to-fuel ratio based on the fuel mass flow rate signal. For a typical three-way catalytic converter, such as the three-way catalytic converter 108, to maintain the oxygen storage level of the three-way catalytic converter 108 at O₂^{Desired-Stored}, \dot{m}_{fuel} is required to be maintained within a narrow band of air-to-fuel ratios near λ is equal to 1.0 for stoichiometric combustion in the internal combustion engine 102.

The control system 120 may be an electronic controller that may include a processor operably associated with other electronic components such as data storage devices and various communication channels. In an embodiment, the control system 120 may be operatively implemented within an engine control unit (ECU) associated with the engine system 100. Moreover, the control system 120 may also configure to receive various other signals indicative of for example, but not limited to, engine load, coolant temperature, and fuel pressure etc.

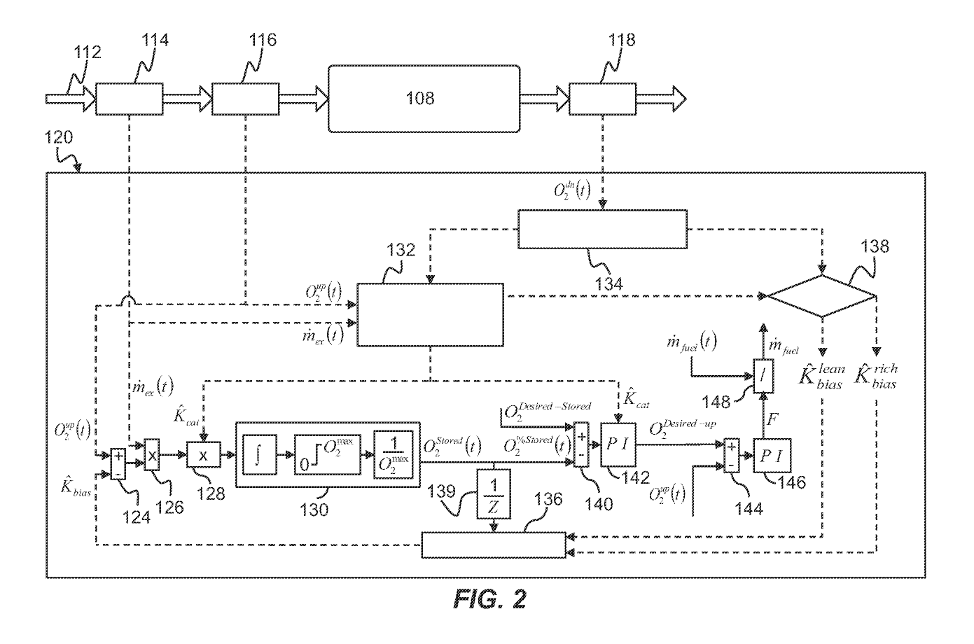

FIG. 2 illustrates a block diagram of the control system 120, according to an embodiment of the present disclosure. As illustrated, O₂^{up}(t) and a first control parameter \check{K}_{bias} are supplied to a first logic element 124. The first logic element 124 may include an adder-subtractor circuit to provide a difference of O₂^{up}(t) and \check{K}_{bias}, where \check{K}_{bias} is a measure of sensor bias and is proportional to an error in the measurement of O₂^{up}(t) by the upstream oxygen sensor 116. The difference of O₂^{up}(t) and \check{K}_{bias} is multiplied with \dot{m}ₑₓ(t), which may be weighted by a pre-defined factor corresponding to oxygen content in exhaust gas 112, in a second logic element 126. The second logic element 126 may include a first multiplier circuit. The output of the second logic element 126 is supplied to a third logic element 128 and multiplied with a second control parameter \check{K}_{cat}, where \check{K}_{cat} is a measure of catalyst gain and is proportional to an initial maximum oxygen storage level O₂^{max} of the three-way catalytic converter 108. The third logic element 128 may include a second multiplier circuit. The output of the third logic element 128 is supplied to a limit integrator 130 and integrated from 0 to O₂^{max} and the output of the limit integrator 130 is divided by O₂^{max} to mathematically determine O₂^{Stored}(t). Thus, a mathematical model to determine O₂^{Stored}(t) is defined by the following Equation #1:

$${O}_{2}^{Stored} ( t ) = {\int }_{0}^{{O}_{2}^{max}} {\hat{K}}_{cat} \frac{1}{{O}_{2}^{max}} {\dot{m}}_{ex} ( t ) ( {O}_{2}^{up} ( t ) - {\hat{K}}_{bias} ) d t \qquad Equation \#1$$

The initial maximum oxygen storage level O₂^{max} of the three-way catalytic converter 108 may be estimated on the newly stored three-way catalytic converter 108 and may be stored in the data storage devices associated with the control system 120. It will apparent to a person having ordinary skill in the art that O₂^{max} may be a indicative of a maximum storage capacity of the three-way catalytic converter 108 and may be determined by various means based on experimental or empirical methods. Moreover, O₂^{max} may have a pre-set value for the three-way catalytic converter 108, and primarily based on the design and size of the three-way catalytic converter 108. Further, the first and the second control parameters \check{K}_{bias} and \check{K}_{cat} are updated in real time by a processing module \check{K}_{bias} 132 using Recursive Least Squares (RLS) algorithm. The processing module 132 is configured to receive real time inputs corresponding to \dot{m}ₑₓ(t), and O₂^{up}(t) from the exhaust gas mass flow sensor 114, and the upstream oxygen sensor 116, respectively and update the control parameters \check{K}_{bias} and \check{K}_{cat} using RLS algorithm. Moreover, the initial values for \check{K}_{bias} and \check{K}_{cat} while updating using RLS algorithm are pre-selected as 0 and 1.0, respectively.

In an embodiment, O₂^{dn}(t) determined by the downstream oxygen sensor 118 may lie in between an upper limit threshold O₂^{dnH} and a lower limit threshold O₂^{dnL}. In an aspect, O₂^{dnH}is indicative of a substantially full state of the three-way catalytic converter 108 which can accept no further oxygen present in the exhaust gas 112. Further, O₂^{dhL} is indicative of a substantially empty state of the three-way catalytic converter 108 which can release no further oxygen. O₂^{dnH} and O₂^{dnL} may be based on a switch in the type of fuel used in the internal combustion engine 102 and updated and/or pre-defined and stored in the data storage devices associated with the control system 120 for the different types of fuel used in the internal combustion engine 102. A real time input proportional to O₂^{dn}(t) from the downstream oxygen sensor 118 is supplied to a triggering module 134, which is configured to trigger the processing module 134 and initiate RLS algorithm to update \check{K}_{bias} and \check{K}_{cat}, when O₂^{dn}(t) is substantially equal to or greater than O₂^{dnH} or substantially equal to or less than O₂^{dnL}. The triggering module 134 may include a trigger circuit.

As described above, the second control parameter \check{K}_{cat} is proportional to O₂^{max} , and \check{K}_{cat} may be accordingly updated using RLS algorithm when the O₂^{dn}(t) is substantially equal to or greater than O₂^{dnH} or substantially equal to or less than O₂^{dnL}. In accordance with an embodiment of the present disclosure, \check{K}_{cat} is updated based on the switch in the type of fuel used in the internal combustion \check{K}_{cat} engine 102. Moreover, \check{K}_{bias} and \check{K}_{cat} may be also updated during a normal operation for the same fuel type whenever O₂^{dn}(t) is substantially equal to or greater than O₂^{dnH} or substantially equal to or less than O₂^{dnL}. This takes care of any change in the performance of the three-way catalytic converter 108 based on the operating condition of the internal combustion engine 102.

Furthermore, the processing module 132 is adapted to determine a maximum and a minimum threshold values \check{K}_{bias-lean} and \check{K}_{bias-rich} for the first control parameter \check{K}_{bias}. \check{K}_{bias-lean} and \check{K}_{bias-rich} may correspond to the value of \check{K}_{bias} when the three-way catalytic converter 108 is at the substantially full and empty states, respectively. Based on the lean mode or the rich mode of operation of the internal combustion engine 102, either \check{K}_{bias-lean} or \check{K}_{bias-rich} is determined and selected to update a module map 136 by means of a switch 138. The module map 136 may include an interpolation process such as linear interpolation to update \check{K}_{bias} as a function of \check{K}_{bias-lean}, \check{K}_{bias-rich}, and a real time relative oxygen storage level O₂^{%Stored}(t) of the three-way catalytic converter 108. The real time relative oxygen storage level O₂^{% Stored}(t) may be indicative of O₂^{Stored}(t) in a scale of 0 to 1.0 and can be determined by factoring O₂^{Stored}(t), determine by the limit integrator 130, using O₂^{max}. Furthermore, a unit delay block 139 is provided to implement a delay using a pre-determined sample time to input the real time percentage oxygen storage level O₂^{% Stored}(t) to update as a function of \check{K}_{bias-lean}, \check{K}_{bias-rich}.

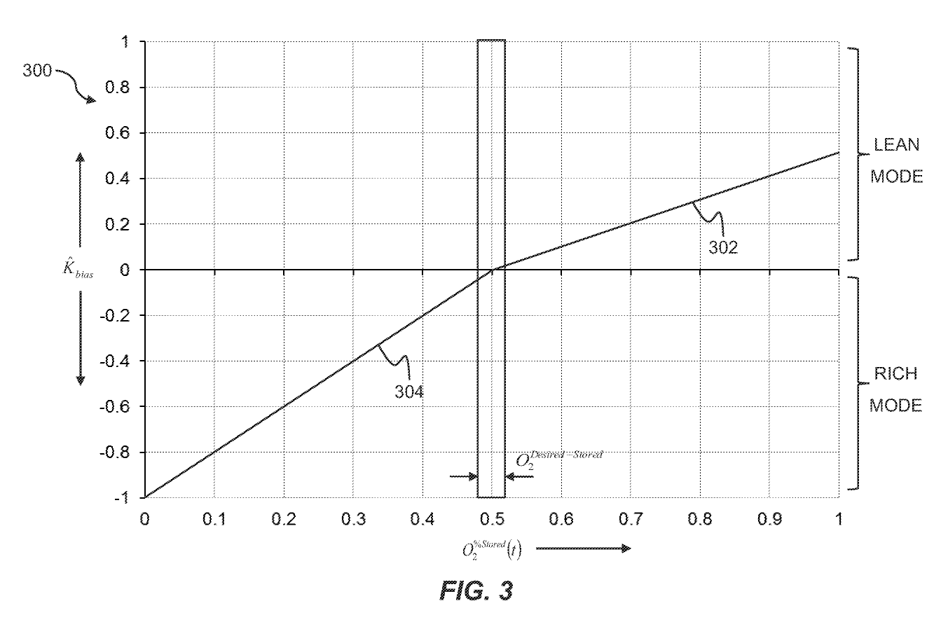

FIG. 3 illustrates a linear interpolation curve 300 used for updating \check{K}_{bias}. As illustrated in FIG. 3, \check{K}_{bias} is plotted along a vertical axis with O₂^{% Stored}(t) increases along a horizontal axis. During the lean mode of operation the interpolation curve 300 is used to updated \check{K}_{bias} based on a first interpolation curve 302 interpolated between O₂^{% Stored}(t) corresponding to O₂^{Desired-Stored} and 1.0. Further, during the rich mode of operation the interpolation curve 300 is used to updated based on a second interpolation curve 304 interpolated between O₂^{% Stored} substantially equal to 0 and O₂^{Desired-Stored}. As illustrated in FIG. 3, in an exemplary embodiment, O₂^{% Stored}(t) corresponding to O₂^{Desired-Stored} is pre-selected at 0.5, which is indicative of a substantially a half filled state of the TCW 108. Moreover, it may be apparent from the interpolation curve 300 that \check{K}_{bias} is equal to 0 for O₂^{% Stored} corresponding to O₂^{Desired-Stored}. Further, \check{K}_{bias} is equal to \check{K}_{bias-lean} and \check{K}_{bias-rich} during the substantially full and empty states of the three-way catalytic converter 108, respectively.

Referring to FIG. 2, O₂^{% Stored}(t) and O₂^{Desired-Stored} are supplied to a fourth logic element 140 to output a first error signal indicative of the deviation of O₂^{Stored}(t) from O₂^{Desired-Stored}. The first error signal indicative of the deviation of O₂^{Stored}(t) from O₂^{Desired-Stored} is supplied to a first proportional-integral controller (PI controller) 142. The first PI controller 142 may use a closed loop PI controller algorithm well known in the art. The first PI controller 142 may include a proportional gain factor (P), and an integral gain factor (I) associated with a proportional control algorithm, and an integral control algorithm, respectively. Further, the first PI controller 142 may determine and generate a first control signal indicative of a desired upstream measured oxygen quantity O₂^{Desired-up} as a function of the proportional gain factor (P), the integral gain factor (I), and the deviation of O₂^{Stored}(t) from O₂^{Desired-Stored}. In an embodiment, the proportional gain factor (P), and the integral gain factor (I) are dynamically updated based on \check{K}_{cat}.

Subsequently, O₂^{Desired-up} and O₂^{up}(t) are supplied to a fifth logic element 144 to output a second error signal indicative of a deviation of O₂^{up}(t) from O₂^{Desired-up}. The second error signal indicative of the deviation of O₂^{up}(t) from O₂^{Desired-up} is supplied to a second PI controller 146, which may determine and generate a second control signal indicative of an emissions factor F corresponding to the desired fuel mass flow rate \dot{m}_{fuel} and/or AFR to minimize the deviation of O₂^{Stored}(t) from O₂^{Desired-Stored}. The emissions factor F may be supplied in a sixth logic element 148 along with a real time fuel mass flow rate \dot{m}_{fuel}(t) to generate the fuel mass flow signal. Further, the control system 120 may further include a look-up table/array including, but not limited to, a set of modulation functions or a pre-defined look-up table for validating the fuel mass flow signal and output electric signals to adjust the fuel supply device 122. It will be apparent to a person having ordinary skill in the art that, the sixth logic elements 148 may act as an electronic signal divider or an electronic mixer that combines two or more electrical or electronic signals to output a composite signal. Further, the logic elements 124, 126, 128, 140, 144, and 148 may include transistors and/or diodes arranged in a circuit to achieve the purpose.

### INDUSTRIAL APPLICABILITY

The industrial applicability of the systems and methods for regulating the fuel mass flow rate in an internal combustion engine to maintain oxygen storage level of a three-way catalytic converter (TWC) at the optimal oxygen storage level described herein will be readily appreciated from the foregoing discussion. The internal combustion engine 102 may be used to power any machine or other device, including on-highway trucks or vehicles, off-highway trucks or machines, earth moving equipment, generators, aerospace applications, locomotive applications, marine applications, pumps, stationary equipment, or other engine powered applications.

The three-way catalytic converter 108 store oxygen present in excess in the exhaust gas when the internal combustion engine 102 is operated in the lean mode. Further, three-way catalytic converter 108 may release oxygen when the internal combustion engine 102 is operated in the stoichiometric mode or the rich mode. The control system 120 is configured to maintain the oxygen storage level at O₂^{Desired-Stored} by regulating the fuel mass flow rate based on emissions factor F, determined by the first PI controller 142 and the second PI controller 146. Further, emissions factor F is estimated based on the real-time oxygen storage level O₂^{Stored}(t), determined the mathematical model. In accordance with an embodiment of the present disclosure, the various control parameters, for example, the first control parameter \check{K}_{bias}, and the second control parameter \check{K}_{cat}, used in the mathematical model to determine O₂^{Stored}(t) are updated using the real time using Recursive Least Squares (RLS) algorithm during the switch in the type of fuel used in the internal combustion engine 102. Moreover, the proportional gain factor (P), and the integral gain factor (I) associated with the first PI controller 142 are also dynamically updated based on the second control parameter \check{K}_{cat}. Thus, the engine system 100 may be operated on the different types of fuel and maintains the tailpipe emissions below the threshold as per the emissions performance standard for the different types of fuel used in the internal combustion engine 102.

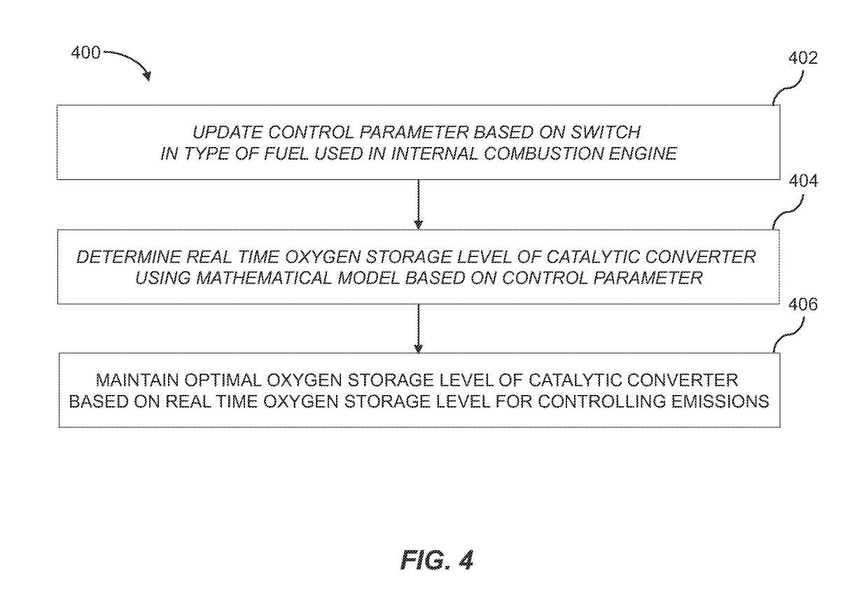

FIG. 4 illustrates a flow chart of a method 400 for operating the engine system 100, according to an aspect of the present disclosure. At step 402, the processing module 132 update at least one of the first and the second control parameters \check{K}_{bias}, and \check{K}_{cat} to be used in the mathematical model to determine O₂^{Stored}(t), based on the switch in a type of fuel used in the internal combustion engine 102. As described above, the control system 120 may include updated and/or pre-defined values corresponding to O₂^{max}, O₂^{dnH} and O₂^{dnL} for the different types of fuel used in the internal combustion engine 102. Further, the triggering module 134 is provided to trigger the processing module 132 and initiate RLS algorithm to update \check{K}_{bias} and \check{K}_{cat}, when O₂^{dn}(t) is substantially equal to O₂^{dnH} or O₂^{dnL}. Specifically, the triggering module 134 determine the lean mode or the rich of operation of the engine system 100 and the processing module 132 determine \check{K}_{bias-lean} and \check{K}_{bias-rich} to accordingly update \check{K}_{bias} using the interpolation curve 300 stored in the module map 136. The processing module 132 also updates \check{K}_{cat} in proportion to O₂^{max} for a given fuel.

At step 404, the control system 120 may determine O₂^{Stored}(t) using the mathematical model based on the control parameters \check{K}_{bias} and \check{K}_{cat}. The mathematical model uses the real time exhaust gas flow rate \dot{m}ₑₓ(t), and the real time measured upstream oxygen quantity O₂^{up}(t) as inputs to determine O₂^{Stored}(t). As, the mathematical model is adaptive to the switch in the type of fuel used, O₂^{Stored}(t) for the given fuel used in the internal combustion engine 102 provides a good measure of real time oxygen storage level of the three-way catalytic converter 108 for the different types of fuel used in the internal combustion engine 102. Subsequently, at step 406, determine the emissions factor F using the adaptive first PI controller 142 and the second PI controller 146 and regulate the real time fuel mass flow rate \dot{m}_{fuel}(t) supplied to the internal combustion engine 102 to maintain the oxygen storage level of the three-way catalytic converter 108 at O₂^{Desired-Stored} for the different types of fuel used in the internal combustion engine 102. As described above, the proportional gain factor (P), and the integral gain factor (I) associated with the first PI controller 142 are also dynamically updated based on \check{K}_{cat} for the given fuel used in the internal combustion engine 102. Thus, the emissions factor F corresponding to the desired fuel mass flow rate and/or AFR to O₂^{Desired-Stored} of the three-way catalytic converter 108 is also dynamically change based on a switch in the type of fuel used.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A method for controlling emissions in an engine system having an internal combustion engine and an exhaust system, the exhaust system including a catalytic converter with oxygen storage capacity, the method comprising:
receiving a real time exhaust gas flow rate;
receiving a real time measured upstream oxygen quantity with respect to the catalytic converter;
determining a real time oxygen storage level of the catalytic converter based on the real time exhaust gas flow rate and the real time measured upstream oxygen quantity; and
maintaining an optimal oxygen storage level of the catalytic converter based on the real time oxygen storage level for different types of fuel used in the internal combustion engine.

2. The method of claim 1, wherein the determining the real time oxygen storage level of the catalytic converter comprises using a mathematical model based on a first control parameter and a second control parameter.

3. The method of claim 2 further comprises updating at least one of the first control parameter and the second control parameter in real time based on a switch in the type of fuel used in the internal combustion engine.

4. The method of claim 3 further comprises:
receiving a real time measured downstream oxygen quantity with respect to the catalytic converter; and
updating at least one of the first control parameter and the second parameter when the real time measured downstream oxygen quantity at least substantially equal to or greater than an upper limit threshold and substantially equal to or less than a lower limit threshold.

5. The method of claim 4, wherein the upper limit threshold of the real time measured downstream oxygen quantity is indicative of a substantially full state of the catalytic converter.

6. The method of claim 4, wherein the lower limit threshold of the real time measured downstream oxygen quantity is indicative of a substantially empty state of the catalytic converter.

7. The method of claim 1, wherein the maintaining the optimal oxygen storage level comprises regulating a fuel mass flow rate substantially close to a desired fuel mass flow rate in the internal combustion engine.

8. The method of claim 7, wherein the regulating a fuel mass flow rate comprises determining the desired fuel mass flow rate corresponding to a stoichiometric combustion in the internal combustion.

9. The method of claim 8, wherein the determining the desired fuel mass flow rate comprises determining a desired upstream measured oxygen quantity based on a deviation of the real time oxygen storage level of the catalytic converter from the optimal oxygen storage level.

10. The method of claim 9 further comprises determining an emissions factor based on a deviation of the real time measured upstream oxygen quantity from the desired upstream measured oxygen quantity.

11. The method of claim 10 further comprises adjusting a fuel supply device based on the emissions factor and a real time fuel mass flow rate for minimizing the deviation of the real time oxygen storage level of the catalytic converter from the optimal oxygen storage level.

12. The method of claim 1, wherein the optimal oxygen storage level of the catalytic converter is corresponding to a substantially a half filled state of the catalytic converter for maintaining tailpipe emissions below a threshold as per an emissions performance standard.

13. A control system for controlling emissions in an engine system having an internal combustion engine configured to operate using different types of fuel, and an exhaust system including a catalytic converter with oxygen storage capacity, the control system is configured to:
update at least one control parameter based on a switch in a type of fuel used in the internal combustion engine;
determine a real time oxygen storage level of the catalytic converter using a mathematical model based on the at least one control parameter; and
output a fuel mass flow rate signal indicative of a desired fuel mass flow rate based on the real time oxygen storage level of the catalytic converter to maintain an optimal oxygen storage level of the catalytic converter.

14. The control system of claim 13 is further configured to:
receive a real time exhaust gas flow rate;
receive a real time measured upstream oxygen quantity with respect to the catalytic converter; and
determine the real time oxygen storage level of the catalytic converter comprises based on the real time exhaust gas flow rate and the real time measured upstream oxygen quantity with respect to the catalytic converter.

15. The control system of claim 13 is further configured to:
receive a real time measured downstream oxygen quantity with respect to the catalytic converter; and
update at least one control parameter when the real time measured downstream oxygen quantity at least substantially equal to or greater than an upper limit threshold and substantially equal to or less than a lower limit threshold.

16. The control system of claim 15, wherein the upper limit threshold is indicative of a substantially full state of the catalytic converter.

17. The control system of claim 15, wherein the lower limit threshold is indicative of a substantially empty state of the catalytic converter.

18. The control system of claim 13, wherein the desired fuel mass flow rate is corresponding to a stoichiometric combustion in the internal combustion.

19. The control system of claim 18 further configured to determine a desired upstream measured oxygen quantity based on a deviation of the real time oxygen storage level of the catalytic converter from the optimal oxygen storage level.

20. The control system of claim 19 further configured to determine an emissions factor based on a deviation of the real time measured upstream oxygen quantity from the desired upstream measured oxygen quantity to output the fuel mass flow rate signal.

21. The control system of claim 20 further configured to adjust a fuel supply device based the fuel mass flow rate signal to minimize the deviation of the real time oxygen storage level of the catalytic converter from the optimal oxygen storage level.

22. The control system of claim 13, wherein the optimal oxygen storage level of the catalytic converter is corresponding to a substantially a half filled state of the catalytic converter to maintain tailpipe emissions below a threshold as per an emissions performance standard.

23. A method of operating an engine system having an internal combustion engine configured to operate using different types of fuel, and an exhaust system including a catalytic converter with oxygen storage capacity, the method comprising:
updating at least one control parameter based on a switch in a type of fuel used in the internal combustion engine;
determining a real time oxygen storage level of the catalytic converter using a mathematical model based on the at least one control parameter; and
maintaining an optimal oxygen storage level of the catalytic converter based on the real time oxygen storage level for controlling emissions.

24. The method of claim 23 further comprising:
receiving a real time exhaust gas flow rate;
receiving a real time measured upstream oxygen quantity with respect to the catalytic converter; and
determining the real time oxygen storage level of the catalytic converter comprises based on the real time exhaust gas flow rate and the real time measured upstream oxygen quantity with respect to the catalytic converter.

25. The method of claim 23 further comprising:
receiving a real time measured downstream oxygen quantity with respect to the catalytic converter; and
updating at least one control parameter when the real time measured downstream oxygen quantity at least substantially equal to or greater than an upper limit threshold and substantially equal to or less than a lower limit threshold.

26. The method of claim 25, wherein the upper limit threshold of the real time measured downstream oxygen quantity is indicative of a substantially full state of the catalytic converter.

27. The method of claim 25, wherein the lower limit threshold of the real time measured downstream oxygen quantity is indicative of a substantially empty state of the catalytic converter.

28. The method of claim 23, wherein the maintaining the optimal oxygen storage level comprises regulating a fuel mass flow rate substantially close to a desired fuel mass flow rate in the internal combustion engine.

29. The method of claim 28, wherein the regulating a fuel mass flow rate comprises determining the desired fuel mass flow rate corresponding to a stoichiometric combustion in the internal combustion.

30. The method of claim 29, wherein the determining the desired fuel mass flow rate comprises determining a desired upstream measured oxygen quantity based on a deviation of the real time oxygen storage level of the catalytic converter from the optimal oxygen storage level.

31. The method of claim 30 further comprises determining an emissions factor based on a deviation of the real time measured upstream oxygen quantity from the desired upstream measured oxygen quantity.

32. The method of claim 31 further comprises adjusting a fuel supply device based on the emissions factor and a real time fuel mass flow rate for minimizing the deviation of the real time oxygen storage level of the catalytic converter from the optimal oxygen storage level.

33. The method of claim 23, wherein the optimal oxygen storage level of the catalytic converter is corresponding to a substantially a half filled state of the catalytic converter.

34. The method of claim 23, wherein the controlling emissions comprises maintaining tailpipe emissions below a threshold as per an emissions performance standard.
